(19) United States
(12) Patent Application Publication
(10) Pub. No.: US 2007/0011462 A1
(43) Pub. Date: Jan. 11, 2007

(54) Computer system and control method thereof

(75) Inventor: Byung-Iae Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/481,839

(22) Filed: Jul. 7, 2006

(30) Foreign Application Priority Data
Jul. 11, 2005 (KR) 2005-62317

(51) Int. Cl. G06F 12/14; H04L 9/00; H04K 1/00; G06F 17/30; G06F 12/00; G06F 13/00; G06F 7/04; G06F 7/58; G06K 19/00; G11C 7/00; H04L 9/32; G06F 11/30

(52) U.S. Cl. 713/183; 713/184; 713/181; 726/17; 713/193

(57) ABSTRACT

A computer system which has a connection port to transmit data is provided with a user input unit through which a user inputs a password; a switch which is turned ON/OFF to transmit data through the connection port; and a processor subsystem which outputs a control signal to control operation of the switch to transmit data through the connection port, when the input password matches a preset password. As a result, the computer system is able to efficiently control data transmission between a processor subsystem and an external storage device.

### CROSS-REFERENCE TO RELATED APPLICATIONS

This application claims all benefits accruing under 35 U.S.C. §119 from Korean Patent Application No. 2005-62317, filed on Jul. 11, 2005, in the Korean Intellectual Property Office, the disclosure of which is incorporated herein by reference.

### BACKGROUND OF THE INVENTION

1. Field of the Invention

The present invention relates to a computer system and a control method thereof, and more particularly, to a computer system which controls data transmission between an external storage device and a processor subsystem, and a control method thereof.

2. Related Art

Recently, data which is stored in a computer system, such as a personal computer (PC), a notebook computer or a workstation, may be transmitted to the outside through a storage medium, such as a floppy disk and a CD-ROM. With the introduction of a local area network (LAN) and a wide area network (WAN) such as the Internet, data stored in the computer system can be accessed from the outside without difficulty. Thus, there is an increased emphasis on the security of data stored in the computer system.

In a typical computer system, data can be read and stored, by way of an input unit, such as a keyboard or a mouse, in a storage device, such as a hard disk drive (HDD), a flash memory card, and a personal computer memory card international association (PCMCIA) card. In addition, the computer system restricts the access of an external storage device through a utility program, to prevent an unauthorized person from accessing data stored in the computer system.

However, such a computer system can be hacked or cracked by an unauthorized person, even if access is restricted. As a result, data remains unsecured.

### SUMMARY OF THE INVENTION

Several aspects and example embodiments of the present invention provide a computer system which efficiently controls data transmission between a processor subsystem and an external storage device, and a security control method thereof.

Additional aspects and/or advantages of the present invention will be set forth in part in the description which follows and, in part, will be obvious from the description, or may be learned by practice of the present invention.

In accordance with an embodiment of the present invention, a computer system which has a connection port to transmit data, and is provided with a user input through which a user inputs a password; a switch which is turned ON/OFF to transmit data through the connection port; and a processor subsystem which outputs a control signal to control the switch to transmit data through the connection port when the password input by a user matches a preset password.

According to an aspect of the present invention, the switch comprises a switching element and an enable terminal, and the switching element is controlled by the control signal supplied by the enable terminal.

According to another aspect of the present invention, the switching element comprises one of a one-way switching element which either reads or writes data, and a two-way switching element which both reads and writes data.

According to another aspect of the present invention, the processor subsystem comprises a microcomputer and an input/output controller hub (ICH) which compare the preset password and the input password and output comparison results, and a logic gate which outputs the control signal based on a combination of the comparison results of the microcomputer and the ICH to the enable terminal.

According to another aspect of the present invention, the logic gate comprises an AND gate.

In accordance with another embodiment of the present invention, a method of controlling a computer which has a connection port to transmit data, comprises receiving a password from a user; determining whether the input password matches a preset password; and outputting a control signal to transmit data through the connection port when the input password matches the preset password according to the determination result.

According to an aspect of the present invention, the determining whether the input password matches the preset password comprises determining whether two input passwords different from each other are identical to the preset password, respectively, to output determined results; and outputting a control signal based on a combination of the output results.

According to another aspect of the present invention, the determining whether the input password matches the preset password comprises outputting the control signal based on a logical AND operation of the output results.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a control block diagram of a computer system according to an embodiment of the present invention; and

FIG. 2 is a control flowchart of the computer system according to the embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

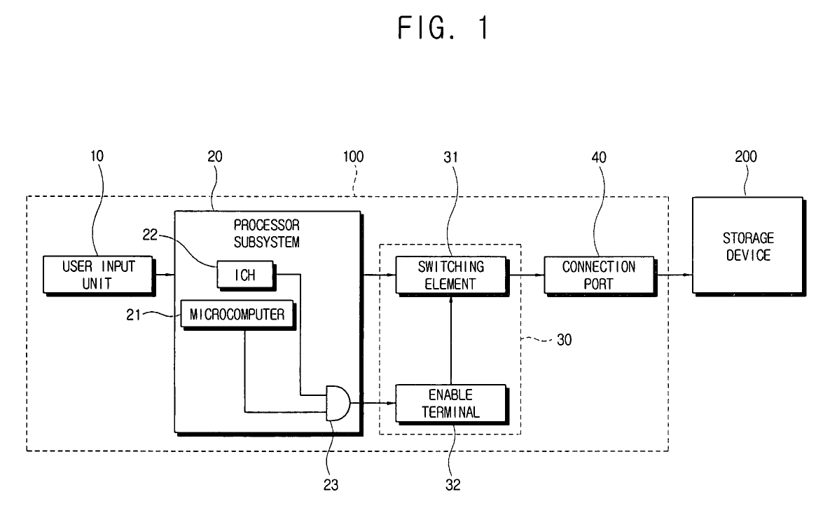

Turning now to FIG. 1, an example computer system according to an embodiment of the present invention is illustrated. As shown in FIG. 1, the computer system 100 comprises a user input unit 10 which receives a password to authenticate a user; a processor subsystem 20; a switch 30 which is turned ON/OFF to transmit data, via a connection port 40.

The user input unit 10 is provided to input or select a predetermined function by a user. The user input unit 10 may be a keyboard or a mouse provided with a plurality of input keys and function buttons.

The switch 30 is arranged to turn ON/OFF to transmit data between a processor subsystem 20 and a storage device 200 (to be described later).

The switch 30 may comprise an enable terminal 32 which receives a control signal; and a switching element 31 which is controlled by the input control signal. Alternatively, the switch 30 may be provided with different switching elements as long as it is turned ON/OFF by the processor subsystem 20. Hereinafter, the switch 30 comprises the enable terminal 32 and the switching element 31 as an example embodiment of the present invention, but is not limited thereto.

The switching element 32 may comprise at least one of an analog switch, an one-way buffer which either reads or writes data; a two-way buffer which both reads and writes data; and a field effect transistor (FET).

The processor subsystem 20 controls the respective parts of the computer system 100. For example, the processor subsystem 20 may comprise, but not limited to, a microcomputer 21 and an input/output (10) controller hub (ICH) 22 which have calculating and controlling functions. The microcomputer 21 may represent one or more central processing units (CPUs). The ICH 22 may provide an interface to one or more I/O devices and the like, such as a user input unit 10. Such an ICH 22 may be integrated into a host chipset along with other components, including, for example, a memory controller and other firmware.

When a predetermined password is input through the user input unit 10, the processor subsystem 20 determines whether the input password is identical to, or matches, a preset password. The processor subsystem 20 outputs a control signal to control the switch 30 based on a determination result. That is, when the input password is identical to the preset password, the processor subsystem 20 controls the switch 30 to be turned ON, thereby allowing the computer system 100 to communicate with the external storage device 200.

Hereinafter, the operation of the processor system 20 storing the preset password in each of the microcomputer 21 and the ICH 22, comparing the password input through the user input part 10 with the preset password, and controlling the switch 30 will be described as an example embodiment of the present invention.

Here, the control signal may comprise one of an enable signal which turns ON the switch 30 to transmit data from the processor subsystem 20 to the connection port 40; and a disable signal which turns OFF the switch 30 not to transmit the data from the processor subsystem 20 to the connection port 40.

The microcomputer 21 according to an embodiment of the present invention determines whether the input password is identical to the preset password, that is, if the input password matches the preset password. When the input password is identical to the preset password, the microcomputer 21 outputs an enable signal for turning ON the switch 30. When the input password is not identical to the preset password, the microcomputer 21 outputs a disable signal for turning OFF the switch 30.

According to another embodiment of the present invention, the ICH 22 controls input/output (10) operations of the computer system 100. The ICH 22 may include a security program configured therein to prevent data from being transmitted to the outside. The ICH 22 may operate an authentication process of the security program and generate one of the enable and disable signals to the switch 30 according to the authentication process.

For example, when the password that is input to be authenticated by the security program is identical to the preset password of the ICH 22, the ICH 22 may output an enable signal for turning ON the switch 30.

According to another embodiment of the present invention, the computer system 100 may further comprise a logic gate 23. Such a logic gate 23 may reside within the processor subsystem 20, as shown in FIG. 1, or alternatively, may reside separately from the processor subsystem 20. The logic gate 23 may comprise at least one of an AND gate, an OR gate, an NOT gate, and an XOR gate arranged to logically combine outputs from the microcomputer 21 and the ICH 22 so as to generate a control signal for turning ON/OFF the switch 30.

As described above, the microcomputer 21 and the ICH 22 may output the control signal to turn the switch 30 ON/OFF. The control signals output from the microcomputer 21 and the ICH 22 are input to the logic gate 23. When the enable signal has a value of “1”, for example, and the disable signal has a value of “0” that are input to the logic gate 23, the logic gate 23 operates as follows.

The AND gate outputs “1” only when both input signals have “1”. The OR gate outputs “1” when one of two input signals has “1”. The NOT gate outputs one value which is different from the other input. The NOT gate outputs “0” when it receives “1”, and outputs “1” when it receives “0”. The XOR gate outputs “0” when both input signals have the same value, and outputs “1” when the both input signals have different values each other.

Hereinafter, the logic gate 23 comprises an AND gate as an example embodiment of the present invention. Only when the control signal output from the microcomputer 21 and the ICH 22 is the enable signal, the AND gate outputs the control signal to the enable terminal 32 to turn ON the switch 30.

The microcomputer 21 and the ICH 22 enable the switch 30, but not limited thereto. Alternatively, any part of the processor subsystem 20 may control operation of the switch 30.

Data is transmitted to a storage device 200 through the connection port 40. The storage device 200 may comprise a hard disk drive (HDD) which is an auxiliary memory device of the computer system 100, an optical disk drive (ODD), and a memory card such as a PCMCIA card, a secure digital (SD) card and a multi-media card (MMC), but not limited thereto. The storage device 200 may be provided in a variety of forms as long as it stores data.

The present invention can be applicable to a server computer and a client computer in a network, such as the Internet. When the computer system 100 according to the present invention comprises a server computer, and when the storage device 200 comprises a client computer, the client computer may be connected with the connection port 40 of the computer system 100. Here, the switch 30 controls data transmission between the computer 100 according to the present invention and the client computer as the storage device 200.

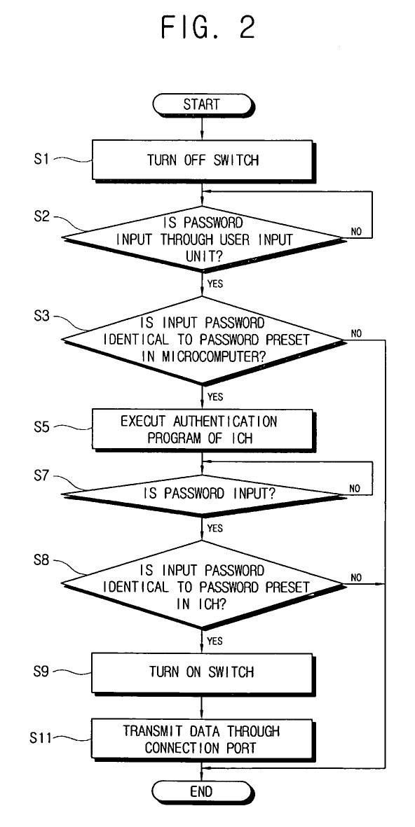

Referring to FIG. 2, the operation of the computer system 100 according to the present invention will be described in detail herein below.

The microcomputer 21 according to the present invention stores the preset password therein to be compared with the password input to authenticate a user.

The switch 30 is turned OFF at operation S1. A user inputs a password, via the user input unit 10, so as to transmit data to the storage device 200 at operation S2.

The processor subsystem 20 determines whether the password input through the user input unit 10 is identical to the password preset in the microcomputer 21 at operation S3. When the input password is identical to the preset password, the microcomputer 21 generates an enable signal to the logic gate 23. When the input password is not identical to the password preset in the microcomputer 21, the microcomputer 21 generates a disable signal to the logic gate 23.

Here, the ICH 22 of the processor system 20 may store a security program therein. When a user executes the security program of the ICH 22 to secure data transmission, the ICH 22 proceeds with the user authentication process at operation S5. When a user inputs a password of the security program to be authenticated at operation S7, the ICH 22 generates an enable signal to the logic gate 23 at operation S8, after authenticating a user. When a user is not authenticated, the ICH 22 generates a disable signal to the logic gate 23.

When the logic gate 23 receives two enable signals, the logic gate 23 outputs the control signal to the enable terminal 32 to enable the switch 30, that is, to turn ON the switch 30. When the logic gate 23 receives one disable signal, the logic gate 23 outputs the control signal to the enable terminal 32 to disable the switch 30, that is, to turn OFF the switch 30. When the enable terminal 32 receives the enable signal from the logic gate 23, the logic gate 23 outputs the enable signal to the switching element 31.

The switching element 31 connects the processor subsystem 20 and the connection port 40 when it receives the enable signal at operation S9. Thus, data can be transmitted between the processor subsystem 20 and the storage device 200 through the connection port 40.

In the foregoing example embodiment, the microcomputer 21 and the ICH 22 have the preset passwords therein, respectively, but not limited thereto. Alternatively, the processor subsystem 20 may store the preset password therein.

In the foregoing example embodiment, the passwords input through the user input unit 10 are compared with the passwords preset in the microcomputer 21 and the ICH 22. Here, the times and method of comparing the input password and the preset password are not limited to what has been described, but are intended to cover other password matching techniques.

Also, there is provided at least one storage device 200 according to an example embodiment of the present invention. However, the switch 30 may be connected with a plurality of storage devices 200 to control data transmission, or connected with one of the plurality of storage devices 200.

As described above, the present invention provides a computer system having an improved security configuration to efficiently control data transmission, and a control method thereof.

Various components of the computer system 100, as shown in FIG. 1, such as the ICH 22, the logic gate 23 and the switch 30 can be integrated into a host chipset, or alternatively, can be implemented in software or hardware, such as, for example, an application specific integrated circuit (ASIC). As such, it is intended that the processes described herein be broadly interpreted as being equivalently performed by software, hardware, or a combination thereof. As previously discussed, software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. Alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Furthermore, the software modules as described can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

What is claimed is:

1. A computer system which has a connection port to transmit data, comprising:
a user input unit through which a user inputs a password;
a switch operable to transmit data through the connection port; and
a processor subsystem which outputs a control signal to control operation of the switch to transmit data through the connection port, when the password input by the user matches a preset password.

2. The computer system according to claim 1, wherein the switch comprises a switching element and an enable terminal, and the switching element is controlled by the control signal supplied by the enable terminal.

3. The computer system according to claim 2, wherein the switching element comprises one of a one-way switching element which either reads or writes data, and a two-way switching element which both reads and writes data.

4. The computer system according to claim 2, wherein the processor subsystem comprises a microcomputer and an input/output controller hub (ICH) which compare the preset password and the input password and output comparison results; and a logic gate which outputs the control signal based on a combination of the comparison results of the microcomputer and the ICH to the enable terminal of the switch.

5. The computer system according to claim 4, wherein the logic gate comprises an AND gate.

6. A method of controlling a computer system which has a connection port to transmit data, comprising:
receiving a password input from a user;
determining whether the input password matches a preset password; and
outputting a control signal to enable data transmission through the connection port, when the input password matches the preset password according to the determination result.

7. The method according to claim 6, wherein the determining whether the input password matches the preset password comprises determining whether two input passwords different from each other are identical to the preset password, respectively, to output determined results; and outputting a control signal based on a combination of the output results.

8. The method according to claim 7, wherein the determining whether the input password matches the preset password comprises outputting the control signal based on a logical AND operation of the output results.

9. The computer system according to claim 1, wherein the processor subsystem comprises:
a microprocessor arranged to generate an enable signal when the input password from the user matches the preset password;
an IO controller hub arranged to generate an enable signal when the input password has been authenticated by a security program; and
a logic gate arranged to logically combine output signals from the microprocessor and the IO controller hub, and produce the control signal to turn the switch “ON” for enabling data transmission between the processor subsystem and an external storage device, via the connection port.

10. The computer system according to claim 9, wherein the logic gate is an AND gate.

11. A computer system comprising:
a user input unit arranged to enable a user to input a password;
a processor subsystem to generate data;
a switch arranged to control data transmission between the processor subsystem and an external storage device, via a connection port,
wherein the processor subsystem outputs a control signal to control operation of the switch, when the password input by the user matches a preset password.

12. The computer system according to claim 12, wherein the processor subsystem comprises:
a microprocessor arranged to generate an enable signal when the input password from the user matches the preset password;
an IO controller hub arranged to generate an enable signal when the input password has been authenticated by a security program; and
a logic gate arranged to logically combine output signals from the microprocessor and the IO controller hub, and produce the control signal to turn the switch “ON” for enabling data transmission between the processor subsystem and the external storage device, via the connection port.

13. The computer system according to claim 12, wherein the switch comprises a switching element and an enable terminal, and the switching element is controlled by the control signal supplied by the enable terminal.

14. The computer system according to claim 13, wherein the switching element comprises one of a one-way switching element which either reads or writes data, and a two-way switching element which both reads and writes data.

15. The computer system according to claim 12, wherein the processor subsystem comprises a microcomputer and an 10 controller hub which compare the preset password and the input password and output comparison results; and a logic gate which outputs the control signal based on a combination of the comparison results of the microcomputer and the IO controller hub to the switch.

16. The computer system according to claim 15, wherein the logic gate comprises an AND gate.
